(19) United States
(12) Patent Application Publication
(10) Pub. No.: US 2005/0064004 A1
(43) Pub. Date: Mar. 24, 2005

(54) Surfactant/solvent mixtures

(75) Inventors: Gerhard Schnabel, Elsenfeld (DE); Gerhard Frisch, Wehrheim (DE); Andreas Rochling, Langenfeld (DE)

Correspondence Address: CONNOLLY BOVE LODGE & HUTZ, LLP, P O BOX 2207, WILMINGTON, DE, 19899, US

(73) Assignee: Bayer CropScience GmbH, Frankfurt am Main (DE)

(21) Appl. No.: 10/943,402

(22) Filed: Sep. 17, 2004

(30) Foreign Application Priority Data
Sep. 19, 2003 (DE) DE 103 43 390.2

(51) Int. Cl. A01N 25/04

(52) U.S. Cl. 424/405

(57) ABSTRACT

The present invention relates to surfactant/solvent mixtures comprising a) one or more solvents of the formula (I):
R—CO—N—R¹R² (I) in which R=H methyl, ethyl or propyl, where
α) if R=H or methyl, R¹ and R² are identical or different and are tert-butyl, (C₅-C₁₂)alkyl or (C₁-C₁₂)hydroxyalkyl, and
β) if R=ethyl or propyl, R¹ and R² are identical or different and are (C₁-C₁₂)alkyl or (C₁-C₁₂)hydroxyalkyl, and b) one or more surfactants. The surfactant/solvent mixture according to the invention is suitable for the preparation of active ingredient formulations.

The present invention relates to combinations of surfactants and solvents (surfactant/solvent mixtures). The surfactant/solvent mixtures can be used for the preparation of formulations of one or more active ingredients, in particular of agrochemical active ingredients.

Solvents which can also be used in the crop protection sector, e.g. aromatic solvents, such as the Solvesso® series from Exxon, or aliphatic solvents such as BP-n-paraffin, ketones, such as isophorone, cyclohexanone and acetophenone, or sulfosuccinates, such as Triton® GR 7 ME from Dow Chem. are known. Also known are crop protection formulations which comprise dimethylformamide, dimethylacetamide or N-methylpyrrolidone (U.S. Pat. No. 6,420,361, JP 2001 302422 A, WO 9951099).

The object of the present invention was to provide a surfactant/solvent mixture which is suitable for the preparation of stable active ingredient formulations.

Surprisingly, it has been found that this object can be achieved by surfactant/solvent mixtures with specific carboxamides.

The present invention thus provides a surfactant/solvent mixture comprising
a) one or more solvents of the formula (I):
   R—CO—NR¹R² (I)
   in which
R=H, methyl, ethyl or propyl, where
α) if R=H or methyl, R¹ and R² are identical or different and are tert-butyl, (C₅-C₁₂)alkyl or (C₁-C₁₂)hydroxyalkyl, preferably tert-butyl, C₅- or C₆-alkyl, and
β) if R=ethyl or propyl, R¹ and R² are identical or different and are (C₁-C₁₂)alkyl or (C₁-C₁₂)hydroxyalkyl, preferably (C₁-C₆)alkyl, and
b) one or more surfactants.

The alkyl radicals and hydroxyalkyl radicals R, R¹ and R² in the formula (I) may be straight-chain or branched. Examples of alkyl radicals R are methyl, ethyl and propyl, such as n-propyl or isopropyl. Examples of alkyl radicals R¹ and R² are methyl, ethyl, propyl, such as n-propyl or isopropyl, butyl, such as n-butyl, or branched butyl, such as sec-butyl, isobutyl or tert-butyl, pentyl, such as n-pentyl or branched pentyl, such as isopentyl or neopentyl, hexyl, such as n-hexyl or branched hexyl, heptyl, such as n-heptyl or branched heptyl, octyl, such as n-octyl or branched octyl, nonyl, such as n-nonyl or branched nonyl, decyl, such as n-decyl or branched decyl, undecyl, such as n-undecyl or branched undecyl, dodecyl, such as n-dodecyl or branched dodecyl. In a preferred embodiment, alkyl radicals R¹ and R² are identical.

Solvents a) present in the surfactant/solvent mixtures according to the invention are, for example, N,N-di-tert-butylformamide, N,N-dipentylformamide, N,N-dihexylformamide, N,N-diheptylformamide, N,N-dioctylformamide, N,N-dinonylformamide, N,N-didecylformamide, N,N-diundecylformamide, N,N-didodecylformamide, N,N-dihydroxymethylformamide, N,N-di-tert-butylacetamide, N,N-dipentylacetamide, N,N-dihexylacetamide, N,N-diheptylacetamide, N,N-dioctylacetamide, N,N-dinonylacetamide, N,N-didecylacetamide, N,N-diundecylacetamide, N,N-didodecylacetamide, N,N-dihydroxymethylacetamide, N,N-dimethylpropionamide, N,N-diethylpropionamide, N,N-dipropylpropionamide, such as N,N-di-n-propylpropionamide or N,N-diisopropylpropionamide, N,N-dibutylpropionamide, such as N,N-di-n-butylpropionamide, N,N-di-sec-butylpropionamide, N,N-diisobutylpropionamide or N,N-di-tert-butylpropionamide, N,N-dipentylpropionamide, N,N-dihexylpropionamide, N,N-diheptylpropionamide, N,N-dioctylpropionamide, N,N-dinonylpropionamide, N,N-didecylpropionamide, N,N-diundecylpropionamide, N,N-didodecylpropionamide, N,N-dimethyl-n-butyramide, N,N-diethyl-n-butyramide, N,N-dipropyl-n-butyramide, such as N,N-di-n-propyl-n-butyramide or N,N-diisopropyl-n-butyramide, N,N-dibutyl-n-butyramide, such as N,N-di-n-butyl-n-butyramide, N,N-di-sec-butyl-n-butyramide, N,N-diisobutyl-n-butyramide, N,N-di-tert-butyl-n-butyramide, N,N-dipentyl-n-butyramide, N,N-dihexyl-n-butyramide, N,N-diheptyl-n-butyramide, N,N-dioctyl-n-butyramide, N,N-dinonyl-n-butyramide, N,N-didecyl-n-butyramide, N,N-diundecyl-n-butyramide, N,N-didodecyl-n-butyramide, N,N-dipentylisobutyramide, N,N-dihexylisobutyramide, N,N-diheptylisobutyramide, N,N-dioctylisobutyramide, N,N-dinonylisobutyramide, N,N-didecylisobutyramide, N,N-diundecylisobutyramide, N,N-didodecylisobutyramide, N,N-pentylhexylformamide, N,N-pentylhexylacetamide, N,N-pentylhexylpropionamide, N,N-pentylhexyl-n-butyramide, N,N-pentylhexylisobutyramide, N,N-methylethylpropionamide, N,N-methyl-n-propylpropionamide, N,N-methylisopropylpropionamide, N,N-methyl-n-butylpropionamide, N,N-methylethyl-n-butyramide, N,N-methyl-n-butyramide, N,N-methylisopropyl-n-butyramide, N,N-methyl-n-butyl-n-butyramide, N,N-methylethylisobutyramide, N,N-methyl-n-propylisobutyramide, N,N-methylisopropylisobutyramide, N,N-methyl-n-butylisobutyramide.

Preference is given to solvents of the formula (I) in which R=ethyl or propyl, such as n-propyl or isopropyl, and R¹ and R² are identical or different, preferably identical, and are (C₁-C₆)alkyl, e.g. methyl, ethyl, propyl, such as n-propyl or isopropyl, butyl, such as n-butyl, or branched butyl, such as sec-butyl, isobutyl or tert-butyl, pentyl, such as n-pentyl or branched pentyl, such as isopentyl or neopentyl, hexyl, such as n-hexyl or branched hexyl.

Surfactants b) present in the surfactant/solvent mixtures according to the invention are, for example, nonaromatic-based surfactants, e.g. those based on heterocycles, olefins, aliphatics or cycloaliphatics, for example surface-active mono- or poly-alkyl-substituted and subsequently derivatized, e.g. alkoxylated, sulfated, sulfonated or phosphated, pyridine, pyrimidine, triazine, pyrole, pyrolidine, furan, thiophene, benzoxazole, benzthiazole and triazole compounds, and/or aromatic-based surfactants, e.g. mono- or poly-alkyl-substituted and subsequently derivatized, e.g. alkoxylated, sulfated, sulfonated or phosphated, benzenes or phenols. The surfactants b) are generally soluble in the solvent phase and are suitable for emulsifying it—together with active ingredients dissolved therein—upon dilution with water (to give the spray liquor). The surfactant/solvent mixtures according to the invention can, for example, comprise nonaromatic or aromatic surfactants or mixtures of nonaromatic and aromatic surfactants.

Examples of surfactants b) are listed below, in which EO=ethylene oxide units, such as PO=propylene oxide units and BO=butylene oxide units:
b1) C₁₀-C₂₄-alcohols which may be alkoxylated, e.g. with 1-60 alkylene oxide units, preferably 1-60 EO and/or 1-30 PO and/or 1-15 BO in any order. The terminal hydroxyl groups of these compounds can be terminally capped by an alkyl, cycloalkyl or acyl radical having 1-24 carbon atoms. Examples of such compounds are:
   Genapol®C, L, O, T, UD, UDD, X products from Clariant, Plurafac®- and Lutensol®A, AT, ON, TO products from BASF, Marlipal®24 and O13 products from Condea, Dehypon® products from Henkel, Ethylan® products from Akzo Nobel, such as Ethylan CD 120.
b2) Anionic derivatives of the products described under b1) in the form of ether carboxylates, sulfonates, sulfates and phosphates and their inorganic salts (e.g. alkali metal and alkaline earth metal) and organic salts (e.g. those based on amine or alkanolamine), such as Genapol®LRO, Sandopane products, hostaphate, Hordaphos® products from Clariant.
   Copolymers consisting of EO, PO and/or BO units, such as, for example, block copolymers, such as the Pluronic® products from BASF and the Synperonic® products from Uniquema with a molecular weight of from 400 to 10⁸.
   Alkyleneoxy adducts of C₁-C₉ alcohols, such as Atlox®5000 from Uniquema or Hoe®-S3510 from Clariant.
b3) Fatty acid and triglyceride alkoxylates, such as the Serdox®NOG products from Condea or alkoxylated plant oils, such as soybean oil, rapeseed oil, corn oil, sunflower oil, cottonseed oil, linseed oil, coconut oil, palm oil, thistle oil, walnut oil, peanut oil, olive oil or rhicinus oil, in particular rapeseed oil, plant oils also being understood as meaning their transesterification products, e.g. alkyl esters, such as rapeseed oil methyl ester or rapeseed oil ethyl ester, for example the Emulsogen® products from Clariant, salts of aliphatic, cycloaliphatic and olefinic carboxylic acids and polycarboxylic acids, and alpha-sulfo fatty acid esters as available from Henkel.
b4) Fatty acid amide alkoxylates, such as the Comperlan® products from Henkel or the Amam® products from Rhodia.
   Alkyleneoxy adducts of alkynediols, such as the Surfynol® products from Air Products. Sugar derivatives, such as amino and amido sugars from Clariant, glucitols from Clariant, alkyl polyglycosides in the form of the APG® products from Henkel or such as sorbitan esters in the form of the Span® or Tween® products from Uniquema or cyclodextrine esters or ethers from Wacker.
b5) Surface-active cellulose and algine, pectin and guar derivatives, such as the Tylose® products from Clariant, the Manutex® products from Kelco and guar derivatives from Cesalpina.
   Alkyleneoxy adducts based on polyol, such as Polyglycol® products from Clariant. Interface-active polyglycerides and derivatives thereof from Clariant.
b6) Sulfosuccinates, alkanesulfonates, paraffin- and olefin sulfonates, such as Netzer IS®, Hoe®S1728, Hostapur®OS, Hostapur®SAS from Clariant, Triton®GR7ME and GR5 from Union Carbide, Empimin® products from Albright and Wilson, Marlon® PS65 from Condea.
b7) Sulfosuccinamates, such as the Aerosol® products from Cytec or the Empimin® products from Albright and Wilson.
b8) Alkylene oxide adducts of fatty amines, quaternary ammonium compounds having 8 to 22 carbon atoms (C₈-C₂₂), such as, for example, the Genamin®C, L, O, T products from Clariant.
b9) Surface-active zwitterionic compounds, such as taurides, betaines and sulfobetaines in the form of Tegotain® products from Goldschmidt, Hostapon® and Arkopon® products from Clariant.
b10) Surface-active compounds based on silicone and/or silane, such as the Tegopren® products from Goldschmidt and the SE® products from Wacker, and the Bevaloid®, Rhodorsil® and Silcolapse® products from Rhodia (Dow Corning, Reliance, GE, Bayer).
b11) Per- or polyfluorinated surface-active compounds, such as Fluowet® products from Clariant, the Bayowet® products from Bayer, the Zonyl® products from DuPont and products of this type from Daikin and Asahi Glass.
b12) Interface-active sulfonamides, e.g. from Bayer.
b13) Interface-active polyacrylic and polymethacrylic derivatives, such as the Sokalan® products from BASF.
b14) Surface-active polyamides, such as modified gelatin or derivatized polyaspartic acid from Bayer and derivatives thereof.
b15) Surface-active polyvinyl compounds, such as modified polyvinylpyrolidone, such as the Luviskol® products from BASF and the Agrimer® products from ISP or the derivatized polyvinylacetates, such as the Mowilith® products from Clariant or the butyrates, such as the Lutonal® products from BASF, the Vinnapas® and the Pioloform® products from Wacker or modified polyvinyl alcohols, such as the Mowiol® products from Clariant.
b16) Surface-active polymers based on maleic anhydride and/or reaction products of maleic anhydride, and maleic anhydride and/or reaction products of copolymers which include maleic anhydride, such as the Agrimer®-VEMA products from ISP.
b17) Surface-active derivatives of montane, polyethylene and polypropylene waxes, such as the Hoechst® waxes or the Licowet® products from Clariant.
b18) Surface-active phosphonates and phosphinates, such as Fluowet®-PL from Clariant.
b19) Poly- or perhalogenated surfactants, such as, for example Emulsogen®-1557 from Clariant.
b20) Phenols which may be alkoxylated, for example phenyl (C₁-C₄)alkyl ethers or (poly)alkoxylated phenols [=phenol (poly)alkylene glycol ethers], for example having 1 to 50 alkyleneoxy units in the (poly)alkyleneoxy moiety, where the alkylene moiety preferably in each case has 1 to 4 carbon atoms, preferably phenol reacted with 3 to 10 mol of alkylene oxide,
   (poly)alkylphenols or (poly)alkylphenol alkoxylates [=polyalkylphenol (poly)alkylene glycol ethers], for example with 1 to 12 carbon atoms per alkyl radical and 1 to 150 alkyleneoxy units in the polyalkyleneoxy moiety, preferably tri-n-butylphenol or triisobutylphenol reacted with 1 to 50 mol of ethylene oxide,
   polyarylphenols or polyarylphenol alkoxylates [=polyarylphenol (poly)alkylene glycol ethers], for example tristyrylphenol polyalkylene glycol ethers with 1 to 150 alkyleneoxy units in the polyalkyleneoxy moiety, preferably tristyrylphenol reacted with 1 to 50 mol of ethylene oxide.
b21) Compounds which formally represent the reaction products of the molecules described under b20) with sulfuric acid or phosphoric acid, and salts thereof neutralized with suitable bases, for example the acidic phosphoric esters of triethoxylated phenol, the acidic phosphoric ester of a nonylphenol reacted with 9 mol of ethylene oxide and the phosphoric ester of the reaction product of 20 mol of ethylene oxide and 1 mol of tristyrylphenol which has been neutralized with triethanolamine.
b22) Benzenesulfonates, such as alkyl- or arylbenzenesulfonates, e.g. (poly)alkyl- and (poly)arylbenzenesulfonates which are acidic and neutralized with suitable bases, for example having 1 to 12 carbon atoms per alkyl radical or having up to 3 styrene units in the polyaryl radical, preferably (linear) dodecylbenzenesulfonic acid and oil-soluble salts thereof, such as, for example, the calcium salt or the isopropylammonium salt of dodecylbenzenesulfonic acid.

The alkyleneoxy units are ethyleneoxy, propyleneoxy and butyleneoxy units, particularly preferably ethyleneoxy units.

Examples of surfactants from the group of nonaromatic-based surfactants are the surfactants of the abovementioned groups b1) to b19), preferably the groups b1), b2), b6) and b8).

Examples of surfactants from the group of aromatic-based surfactants are the surfactants of the abovementioned groups b20)-b22),
preferably phenol reacted with 4 to 10 mol of ethylene oxide, available commercially, for example, in the form of the Agrisol® products (Akcros),
triisobutylphenol reacted with 4 to 50 mol of ethylene oxide, commercially available, for example, in the form of the Sapogenat® T products (Clariant),
nonylphenol reacted with 4 to 50 mol of ethylene oxide, commercially available, for example, in the form of the Arkopal® products (Clariant),
tristyrylphenol reacted with 4 to 150 mol of ethylene oxide, for example from the Soprophor® series, such as Soprophor® FL, Soprophor® 3D33, Soprophor® BSU, Soprophor® 4D-384, Soprophor® CY/8 (Rhodia), and
acidic (linear) dodecylbenzenesulfonate, commercially available, for example, in the form of the Marlon® products (Hüls).

Preferred surfactants (b) are, e.g. alkoxylated C₁₀-C₂₄-alcohols (b1) and anionic derivatives thereof (b2), such as sulfates, sulfonates and phosphates, alkoxylated plant oils (b3), alkoxylated phenols (b20) and reaction products thereof in sulfuric acid or phosphoric acid (b21) and alkylbenzenesulfonates (b22).

The weight ratio of solvent a) to surfactant b) is generally in the range from 10 000:1 to 1:99, preferably from 1000:1 to 10:90, the solvent a) is particularly preferably in excess relative to the surfactant b), e.g. in the weight ratio from 100:1 to 2:1.

The surfactant/solvent mixtures according to the invention are suitable, for example, for the preparation of active ingredient formulations such as emulsions and suspensions and concentrates or granules thereof, such as water-emulsifiable granules, in particular of liquid active ingredient formulations, such as oil suspensions, oil suspension concentrates, suspoemulsions, suspoemulsion concentrates, emulsions, e.g. W/O- or O/W-based ones, emulsion concentrates, microemulsions, microemulsion concentrates, and (aqueous) spray liquors obtainable therefrom.

The invention thus also provides active ingredient formulations, in particular agrochemical active ingredient formulations, such as liquid agrochemical, e.g. herbicidal, insecticidal or fungicidal, active ingredient formulations comprising
(1) one or more active ingredients, in particular agrochemical, e.g. herbicidal, insecticidal or fungicidal, active ingredients,
(2) the surfactant/solvent mixture according to the invention,
(3) optionally further organic solvents and
(4) optionally customary auxiliaries and additives, such as thickeners and thixotropic agents, wetting agents, anti-drift agents, adhesives, penetration agents, preservatives and frost protection agents, antioxidants, fillers, carrier substances, dyes, fragrances, antifoams, fertilizers, evaporation inhibitors, and agents which influence the pH and the viscosity, and
(5) optionally water.

Using the surfactant/solvent mixtures according to the invention it is possible to prepare stable active ingredient formulations, in particular of active ingredients which are sparingly soluble in water, e.g. those with a solubility of less than 5 g of active ingredient/l of water. These active ingredients may, for example, be dyes, agrochemical active ingredients, adhesives, disintegrants, pharmaceutical or veterinary medicinal active ingredients, cleaners, fragrances or proteins, preferably agrochemical active ingredients.

Suitable agrochemical active ingredients (1) are, for example, herbicides, insecticides, fungicides (preferably those which are not azole compounds), safeners and growth regulators. Preference is given to herbicides, e.g. leaf-active herbicides such as ALS inhibitors (e.g. sulfonamides, such as flucarbazone, propoxycarbazone or amicarbazone or sulfonylureas, such as mesosulfuron, iodosulfuron, amidosulfuron, foramsulfuron), diflufenican, bromoxynil-containing or ioxynil-containing products, herbicides from the class of aryloxyphenoxy propionates, such as fenoxaprop-p-ethyl, sugarbeet herbicides, such as desmedipham, phenmedipham, ethofumesate or metamitron, or else active ingredients from the class of HPPD inhibitors (e.g. isoxaflutole, sulcotrione, mesotrione).

If the active ingredients contain one or more asymmetric carbon atoms or else double bonds which are not given separately, all isomers are included anyway. The possible stereoisomers defined by their specific three-dimensional shape, such as enantiomers, diastereoisomers, Z and E isomers are all included and can be obtained by customary methods from mixtures of the stereoisomers, or else be prepared by stereoselective reactions in combination with the use of stereochemically pure starting materials. Said stereoisomers in pure form and also their mixtures can thus be used according to the invention.

For the purposes of the present invention, besides the neutral compounds, the active ingredients present as component in the active ingredient formulations according to the invention are always also understood as meaning their salts with inorganic and/or organic counterions. Thus, for example, sulfonylureas can, for example, form salts in which the hydrogen of the —SO₂—NH group is replaced by a cation suitable for agriculture. These salts are, for example, metal salts, in particular alkali metal salts or alkaline earth metal salts, in particular sodium and potassium salts, and also ammonium salts or salts with organic amines. Salt formation can likewise take place by the addition reaction of an acid onto basic groups, such as, for example, amino and alkylamino. Suitable acids for this are strong inorganic and organic acids, for example HCl, HBr, H₂SO₄ or HNO₃.

Herbicides present in the agrochemical compositions according to the invention are, for example, ALS inhibitors (acetolactate synthetase inhibitors) or herbicides other than ALS inhibitors, such as herbicides from the group of carbamates, thiocarbamates, haloacetanilides, substituted phenoxy-, naphthoxy- and phenoxyphenoxycarboxylic acid derivatives, and heteroaryloxyphenoxyalkane carboxylic acid derivatives, such as quinolyloxy-, quinoxalyloxy-, pyridyloxy-, benzoxazolyloxy- and benzothiazolyloxyphenoxyalkane carboxylic esters, cyclohexanedione modifications, phosphorus-containing herbicides, e.g. of the glufosinate type or of the glyphosate type, and S-(N-aryl-N-alkylcarbamoylmethyl)dithiophosphoric esters.

The ALS inhibitors are, in particular, imidazolinones, pyrimidinyloxypyridinecarboxylic acid derivatives, pyrimidyloxybenzoic acid derivatives, triazolopyrimidinesulfonamide derivatives and sulfonamides, preferably from the group of sulfonylureas.

Preferred ALS inhibitors originate from the series of sulfonylureas, e.g. pyrimidine- or triazinylaminocarbonyl-[benzene-, pyridine-, pyrazole-, thiophene- and (alkylsulfonyl)alkylamino-]sulfamides. Preferred substituents of the pyrimidine ring or triazine ring are alkoxy, alkyl, haloalkoxy, haloalkyl, halogen or dimethylamino, where all substituents can be combined independently of one another. Preferred substituents in the benzene, pyridine, pyrazole, thiophene or (alkylsulfonyl)alkylamino moiety are alkyl, alkoxy, halogen, such as F, Cl, Br or I, amino, alkylamino, dialkylamino, acylamino, such as formylamino, nitro, alkoxycarbonyl, aminocarbonyl, alkylaminocarbonyl, dialkylaminocarbonyl, alkoxyaminocarbonyl, haloalkoxy, haloalkyl, alkylcarbonyl, alkoxyalkyl, alkylsulfonylaminoalkyl, (alkanesulfonyl)alkylamino. Such suitable sulfonylureas are, for example

A1) phenyl- and benzylsulfonylureas and related compounds, e.g.
1-(2-chlorophenylsulfonyl)-3-(4-methoxy-6-methyl-1, 3, 5-triazin-2-yl)urea (chlorsulfuron),
1-(2-ethoxycarbonylphenylsulfonyl)-3-(4-chloro-6-methoxypyrimidin-2-yl)urea (chlorimuron-ethyl),
1-(2-methoxyphenylsulfonyl)-3-(4-methoxy-6-methyl-1, 3, 5-triazin-2-yl)urea (metsulfuron-methyl),
1-(2-chloroethoxyphenylsulfonyl)-3-(4-methoxy-6-methyl-1, 3, 5-triazin-2-yl)urea (triasulfuron),
1-(2-methoxycarbonylphenylsulfonyl)-3-(4,6-dimethylpyrimidin-2-yl)urea (sulfometuron-methyl),
1-(2-methoxycarbonylphenylsulfonyl)-3-(4-methoxy-6-methyl-1,3,5-triazin-2-yl)-3-methylurea (tribenuron-methyl),
1-(2-methoxycarbonylbenzylsulfonyl)-3-(4,6-dimethoxypyrimidin-2-yl)urea (bensulfuron-methyl),
1-(2-methoxycarbonylphenylsulfonyl)-3-(4,6-bis(difluoromethoxy)pyrimidin-2-yl)urea (primisulfuron-methyl),
3-(4-ethyl-6-methoxy-1,3,5-triazin-2-yl)-1-(2,3-dihydro-1,1-dioxo-2-methylbenzo[b]thiophene-7-sulfonyl)urea (EP-A 0 796 83),
3-(4-ethoxy-6-ethyl-1,3,5-triazin-2-yl)-1-(2,3-dihydro-1,1-dioxo-2-methylbenzo[b]thiophene-7-sulfonyl)urea (EP-A 0 079 683),
3-(4-methoxy-6-methyl-1,3,5-triazin-2-yl)-1-(2-methoxycarbonyl-5-iodophenylsulfonyl)urea (iodosulfuron-methyl and its salts, such as the sodium salt, WO 92/13845),
DPX-66037, triflusulfuron-methyl (see Brighton Crop Prot. Conf.—Weeds—1995, p. 853),
CGA-277476, (see Brighton Crop Prot. Conf.—Weeds—1995, p. 79),
methyl-2-[3-(4,6-dimethoxypyrimidin-2-yl)ureidosulfonyl]4-methanesulfonamidomethyl benzoate (mesosulfuron-methyl and its salts, such as the sodium salt, WO 95/10507),
N,N-dimethyl-2-[3-(4,6-dimethoxypyrimidin-2-yl)ureidosulfonyl]4-formylaminobenzamide (foramsulfuron and its salts, such as the sodium salt, WO 95/01344);

A2) thienylsulfonylureas, e.g.
1-(2-methoxycarbonylthiophen-3-yl)-3-(4-methoxy-6-methyl-1,3,5-triazin-2-yl)urea (thifensulfuron-methyl);

A3) pyrazolylsulfonylureas, e.g.
1-(4-ethoxycarbonyl-1-methylpyrazol-5-ylsulfonyl)-3-(4,6-dimethoxypyrimidin-2-yl)urea (pyrazosulfuron-methyl);
methyl 3-chloro-5-(4,6-dimethoxypyrimidin-2-ylcarbamoylsulfamoyl)-1-methylpyrazole-4-carboxylate (EP-A 0 282 613);
methyl 5-(4,6-dimethylpyrimidin-2-ylcarbamoylsulfamoyl)-1-(2-pyridyl)pyrazole4-carboxylate (NC-330, see Brighton Crop Prot. Conference ‘Weeds’ 1991, Vol. 1, p. 45 ff.),
DPX-A8947, azimsulfuron, (see Brighton Crop Prot. Conf. ‘Weeds’ 1995, p. 65);

A4) sulfondiamide derivatives, e.g.
3-(4,6-dimethoxypyrimidin-2-yl)-1-(N-methyl-N-methylsulfonylaminosulfonyl)urea (amidosulfuron) and its structure analogs (EP-A 0 131 258 and Z. Pfl. Krankh. Pfl. Schutz, special edition Xii, 489497 (1990));

A5) pyridylsulfonylureas, e.g.
1-(3-N,N-dimethylaminocarbonylpyridin-2-ylsulfonyl)-3-(4,6-dimethoxypyrimidin-2-yl)urea (nicosulfuron),
1-(3-ethylsulfonylpyridin-2-ylsulfonyl)-3-(4,6-dimethoxypyrimidin-2-yl)urea (rimsulfuron),
methyl 2-[3-(4,6-dimethoxypyrimidin-2-yl)ureidosulfonyl]-6-trifluoromethyl-3-pyridinecarboxylate, sodium salt (DPX-KE 459, flupyrsulfuron, see Brighton Crop Prot. Conf. Weeds, 1995, p. 49), and trifloxysulfuron and its sodium salt;

A6) alkoxyphenoxysulfonylureas, as described, for example, in EP-A 0 342 569, preferably 3-(4,6-dimethoxypyrimidin-2-yl)-1-(2-ethoxyphenoxy)sulfonylurea (ethoxysulfurone) or its salt;

A7) imidazolylsulfonylureas, e.g.
MON 37500, sulfosulfuron (see Brighton Crop Prot. Conf. Weeds, 1995, p: 57), and other related sulfonylurea derivatives and mixtures thereof.

Typical representatives of these active ingredients are, inter alia, the compounds listed below and salts thereof: amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, flupyrsulfuron-methyl-sodium, halosulfuron-methyl, imazosulfuron, metsulfuron-methyl, nicosulfuron, oxasulfuron, primisulfuron-methyl, prosulfuron, pyrazosulfuron-ethyl, rimsulfuron, sulfometuron-methyl, sulfosulfuron, thifensulfuron-methyl, triasulfuron, tribenuron-methyl, triflusulfuron-methyl, trifloxysulfuron and its sodium salt, iodosulfuron-methyl and its sodium salt (WO 92/13845), mesosulfuron-methyl and its sodium salt (Agrow No. 347, Mar. 3, 2000, page 22 (PJB Publications Ltd. 2000)) and foramsulfuron and its sodium salt (Agrow No. 338, Oct. 15, 1999, page 26 (PJB Publications Ltd. 1999)).

The active ingredients listed above are known, for example, from The Pesticide Manual, 12th edition (2000), The British Crop Protection Council, or the literature references listed after the individual active ingredients.

Further suitable ALS inhibitors are, for example,

B) imidazolinones, e.g.
methyl 2-(4-isopropyl-4-methyl-5-oxo-2-imidazolin-2-yl)-5-methylbenzoate and 2-(4-isopropyl-4-methyl-5-oxo-2-imidazolin-2-yl)₄-methylbenzoic acid (imazamethabenz),
5-ethyl-2-(4-isopropyl-4-methyl-5-oxo-2-imidazolin-2-yl)pyridine-3-carboxylic acid (imazethapyr),
2-(4-isopropyl-4-methyl-5-oxo-2-imidazolin-2-yl)quinoline-3-carboxylic acid (imazaquin),
2-(4-isopropyl-4-methyl-5-oxo-2-imidazolin-2-yl)pyridine-3-carboxylic acid (imazapyr),
5-methyl-2-(4-isopropyl-4-methyl-5-oxo-2-imidazolin-2-yl)pyridine-3-carboxylic acid (imazethamethapyr);

C) triazolopyrimidinesulfonamide derivatives, e.g.
N-(2,6-difluorophenyl)-7-methyl-1,2,4-triazolo[1,5-c]pyrimidine-2-sulfonamide (flumetsulam),
N-(2,6-dichloro-3-methylphenyl)-5,7-dimethoxy-1,2,4-triazolo[1,5-c]pyrimidine-2-sulfonamide,
N-(2,6-difluorophenyl)-7-fluoro-5-methoxy-1,2,4-triazolo[1,5-c]pyrimidine-2-sulfonamide,
N-(2,6-dichloro-3-methylphenyl)-7-chloro-5-methoxy-1,2,4-triazolo[1,5-c]pyrimidine-2-sulfonamide,
N-(2-chloro-6-methoxycarbonyl)-5,7-dimethyl-1,2,4-triazolo[1,5-c]pyrimidine-2-sulfonamide (EP-A 0 343 752, U.S. Pat. No. 4,988,812);

D) pyrimidinyloxypyridinecarboxylic acid or pyrimidinyloxybenzoic acid derivatives, e.g.
benzyl 3-(4,6-dimethoxypyrimidin-2-yl)oxypyridine-2-carboxylate (EP-A 0 249 707),
methyl 3-(4,6-dimethoxypyrimidin-2-yl)oxypyridine-2-carboxylate (EP-A 0 249 707),
2,6-bis[(4,6-dimethoxypyrimidin-2-yl)oxy]benzoic acid (EP-A 0 321 846),
1-(ethoxycarbonyloxyethyl) 2,6-bis[(4,6-dimethoxypyrimidin-2-yl)oxy]benzoate (EP-A 0 472 113).

The herbicidal active ingredients other than ALS inhibitors present in the herbicidal compositions according to the invention are, for example, herbicides from the group of carbamates, thiocarbamates, haloacetanilides, substituted phenoxy-, naphthoxy- and phenoxyphenoxycarboxylic acid derivatives, and heteroaryloxyphenoxyalkanecarboxylic acid derivatives, such as quinolyloxy-, quinoxalyloxy-, pyridyloxy-, benzoxazolyloxy- and benzothiazolyloxyphenoxyalkanecarboxylic esters, cyclohexanedione modifications, and S-(N-aryl-N-alkylcarbamoylmethyl)dithiophosphoric esters. Preference here is given to phenoxycarboxylic, phenoxyphenoxy- and heteroaryloxyphenoxycarboxylic esters and salts, and herbicides such as bentazon, cyanazine, atrazine, dicamba or hydroxybenzonitriles such as bromoxynil or ioxynil and esters thereof and other leaf herbicides.

Suitable herbicidal active ingredients other than ALS inhibitors which may be present as a component in the agrochemical compositions according to the invention are, for example:

E) herbicides of the phenoxyphenoxy- and heteroaryloxyphenoxycarboxylic acid derivative type, such as

E1) phenoxyphenoxy and benzyloxyphenoxycarboxylic acid derivatives, e.g.
methyl 2-(4-(2,4-dichlorophenoxy)phenoxy)propionate (diclofop-methyl),
methyl 2-(4-(4-bromo-2-chlorophenoxy)phenoxy)propionate (DE-A 26 01 548),
methyl 2-(4-(4-bromo-2-fluorophenoxy)phenoxy)propionate (U.S. Pat. No. 4,808,750),
methyl 2-(4-(2-chloro-4-trifluoromethylphenoxy)phenoxy)propionate (DE-A 24 33 067),
methyl 2-(4-(2-fluoro-4-trifluoromethylphenoxy)phenoxy)propionate (U.S. Pat. No. 4,808,750),
methyl 2-(4-(2,4-dichlorobenzyl)phenoxy)propionate (DE-A 24 17 487),
ethyl 4-(4-(4-trifluoromethylphenoxy)phenoxy)pent-2-enoate,
methyl 2-(4-(4-trifluoromethylphenoxy)phenoxy)propionate (DE-A 24 33 067);

E2) “mononuclear” heteroaryloxyphenoxyalkanecarboxylic acid derivatives, e.g.
ethyl 2-(4-(3,5-dichloropyridyl-2-oxy)phenoxy)propionate (EP-A 0 002 925),
propargyl 2-(4-(3,5-dichloropyridyl-2-oxy)phenoxy)propionate (EP-A 0 003 114),
methyl 2-(4-(3-chloro-5-trifluoromethyl-2-pyridyloxy)phenoxy)propionate (EP-A 0 003 890),
ethyl 2-(4-(3-chloro-5-trifluoromethyl-2-pyridyloxy)phenoxy)propionate (EP-A 0 003 890),
propargyl 2-(4-(5-chloro-3-fluoro-2-pyridyloxy)phenoxy)propionate (EP-A 0 191 736),
butyl 2-(4-(5-trifluoromethyl-2-pyridyloxy)phenoxy)propionate (fluazifop-butyl);

E3) “binuclear” heteroaryloxyphenoxyalkanecarboxylic acid derivatives, e.g.
methyl and ethyl 2-(4-(6-chloro-2-quinoxalyloxy)phenoxy)propionate (quizalofopmethyl and quizalofopethyl),
methyl 2-(4-(6-fluoro-2-quinoxalyloxy)phenoxy)propionate (see J. Pest. Sci. Vol.10, 61 (1985)),
2-isopropylideneaminooxyethyl 2-(4-(6-chloro-2-quinoxalyloxy)phenoxy)propionate (propaquizafop),
ethyl 2-(4-(6-chlorobenzoxazol-2-yloxy)phenoxy)propionate (fenoxaprop-ethyl), its D(+) isomer (fenoxaprop-p-ethyl) and ethyl 2-(4-(6-chlorobenzothiazol-2-yloxy)phenoxy)propionate (DE-A 26 40 730),
tetrahydro-2-furylmethyl 2-(4-(6-chloroquinoxalyloxy)phenoxy)propionate (EP-A 0 323 727);

E4) phenoxycarboxylic acid derivatives, such as
2,4-D, 2,4-DP, 2,4-DB, CMPP and MCPA and esters and salts thereof;

F) chloroacetanilides, e.g.
N-methoxymethyl-2,6-diethylchloroacetanilide (alachlor),
N-(3-methoxyprop-2-yl)-2-methyl-6-ethylchloroacetanilide (metolachlor),
N-(3-methyl-1,2,4-oxadiazol-5-ylmethyl)chloroacet-2,6-dimethylanilide,
N-(2,6-dimethylphenyl)-N-(1-pyrazolylmethyl)chloroacetamide (metazachlor);

G) thiocarbamates, e.g.
S-ethyl N,N-dipropylthiocarbamate (EPTC),
S-ethyl N,N-diisobutylthiocarbamate (butylate);

H) cyclohexanedione oximes, e.g.
methyl 3-(1-allyloxyiminobutyl)₄-hydroxy-6,6-dimethyl-2-oxocyclohex-3-enecarboxylate (alloxydim),
2-(1-ethoxyiminobutyl)-5-(2-ethylthiopropyl)-3-hydroxycyclohex-2-en-1-one (sethoxydim),
2-(1-ethoxyiminobutyl)-5-(2-phenylthiopropyl)-3-hydroxycyclohex-2-en-1-one (cloproxydim),
2-(1-(3-chloroallyloxy)iminobutyl)-5-(2-ethylthiopropyl)-3-hydroxycyclohex-2-en-1-one,
2-(1-(3-chloroallyloxy)iminopropyl)-5-(2-ethylthiopropyl)-3-hydroxycyclohex-2-en-1-one (clethodim),
2-(1-ethoxyiminobutyl)-3-hydroxy-5-(thian-3-yl)cyclohex-2-enone (cycloxydim),
2-(1-ethoxyiminopropyl)-5-(2,4,6-trimethylphenyl)-3-hydroxycyclohex-2-en-1-one (tralkoxydim);

I) benzoylcyclohexanediones, e.g.
2-(2-chloro-4-methylsulfonylbenzoyl)cyclohexane-1,3-dione (SC-0051, EP-A 0 137 963), 2-(2-nitrobenzoyl)4,4-dimethylcyclohexane-1,3-dione (EP-A 0 274 634),
2-(2-nitro-4-methylsulfonylbenzoyl)4,4-dimethylcyclohexane-1,3-dione (WO 91/13548, mesotrione);

J) S-(N-aryl-N-alkylcarbamoylmethyl)dithiophosphonic esters, such as S-[N-(4-chlorophenyl)-N-isopropylcarbamoylmethyl]O,O-dimethyldithiophosphate (anilophos).

K) Alkylazines, for example as described in WO-A 97/08156, WO-A-97/31904, DE-A-19826670, WO-A-98/15536, WO-A-8/15537, WO-A-98/15538, WO-A-98/15539, and also DE-A-19828519, WO-A-98/34925, WO-A-98/42684, WO-A-99/18100, WO-A-99/19309, WO-A-99/37627 and WO-A-99/65882, preferably those of the formula (I) 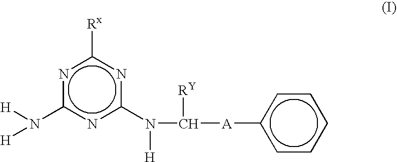
in which
R^{X} is (C₁-C₄)-alkyl or (C₁-C₄)-haloalkyl;
R^{Y} is (C₁-C₄)-alkyl, (C₃-C₆)-cycloalkyl or (C₃-C₆)-cycloalkyl-(C₁-C₄)-alkyl and
A is —CH₂—, —CH₂—CH₂—, —CH₂—CH₂—CH₂—, —O—, —CH₂—CH₂—O—, —CH₂—CH₂—CH₂—O—,
   particularly preferably those of the formula I1-I7

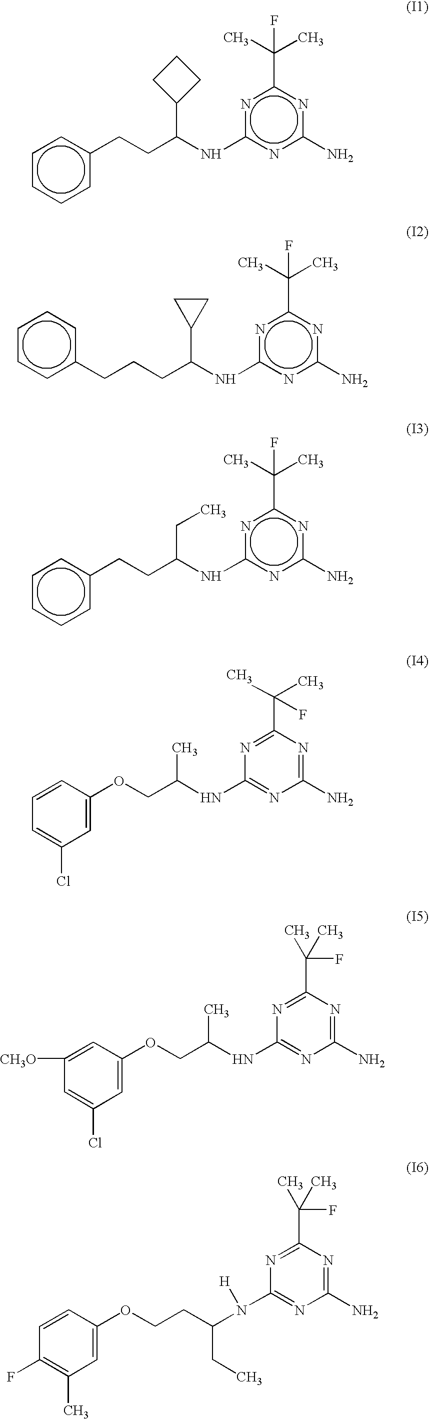

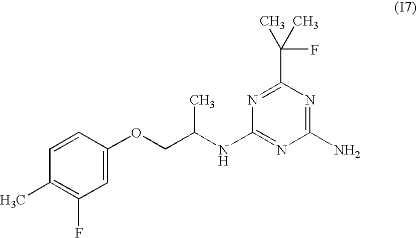

The herbicides of group B to K are known, for example, from the publications specified above in each case and from, The Pesticide Manual, 12th edition, 2000, The British Crop Protection Council, Agricultural Chemicals Book II—Herbicides—, by W. T. Thompson, Thompson Publications, Fresno Calif., USA 1990 and Farm Chemicals Handbook '90, Meister Publishing Company, Willoughby Ohio, USA, 1990. Examples of the agrochemical active ingredients present in the active ingredient formulations according to the invention are:
acetochlor, aclonifen, alachlor, amidochlor, amidosulfuron, bensulfuron-methyl, bitertanol, bromoxynil octanoate, butachlor, chlormequat chloride, chlorsulfuron, cinosulfuron, clodinafop-propargyl, cypermethrine, 2,4-D ester, 2,4-DB ester, 2,4-DP ester, CMPP ester, MCPA ester, deltamethrine, desmedipham, diclofop-methyl, diflufenican, ethofumesate, fenoxaprop-ethyl, fipronil, fluoroglycofen, foramsulfuron, imazapyr, imazosulfuron, iodosulfuron-methyl, imidacloprid, ioxynil octanoate, isoxaflutol, lactofen, mesosulfuron-methyl, metolachlor, metsulfuron-methyl, metamitron, nicosulfuron, oxyfluorfen, pendimethaline, phenmedipham, primisulfuron-methyl, propaquizafop, pyrazosulfuron-methyl, rimsulfuron, tebuconazole, triflusulfuron-methyl, trifloxystrobin, trifluralin, iodosulfuron, prochloraz, amitraz, oxazinone, oxadiargyl, metamitron, mefenpyr-diethyl, phenmedipham, desmedipham and isoxadifen-ethyl, and salts thereof, e.g. the sodium salts.

Examples of suitable further organic solvents (3) which are optionally present in the active ingredient formulations according to the invention are nonpolar solvents, polar protic or aprotic dipolar solvents and mixtures thereof. Examples of further organic solvents for the purposes of the invention are
aliphatic or aromatic hydrocarbons, such as mineral oils, paraffins or toluene, xylenes and naphthalene derivatives, in particular 1-methylnaphthalene, 2-methylnaphthalene, C₆-C₁₆-aromatic mixtures, such as, for example, the Solvesso® series (ESSO) with the grades Solvesso® 100 (b.p. 162-177° C.), Solvesso® 150 (b.p. 187-207° C.) and Solvesso® 200 (b.p. 219-282° C.) and 6-20 C aliphatics, which may be linear or cyclic, such as the products of the Shellsol® series, grades T and K or BP-n paraffins,
halogenated aliphatic or aromatic hydrocarbons, such as methylene chloride or chlorobenzene,
mono- and/or polybasic esters, such as, for example, triacetin (acetic triglyceride), butyrolactone, propylene carbonate, triethyl citrate and phthalic (C₁-C₂₂)alkyl esters, specifically phthalic (C₄-C₈)alkyl esters,
ethers, such as diethyl ether, tetrahydrofuran (THF), dioxane, alkylene glycol monoalkyl ethers and dialkyl ethers, such as, for example, propylene glycol monomethyl ether, specifically Dowanol® PM (propylene glycol monomethyl ether), propylene glycol monoethyl ether, ethylene glycol monomethyl ether or monoethyl ether, diglyme and tetraglyme,
ketones, for example water-miscible ketones, such as acetone, or water-immiscible ketones such as cyclohexanone or isophorone,
nitriles, such as acetonitrile, propionitrile, butyronitrile and benzonitrile,
sulfoxides and sulfones, such as dimethyl sulfoxide (DMSO) and sulfolan, and
oils of natural origin, e.g. plant oils, such as corn oil and rapeseed oil and transesterification products thereof, such as rapeseed oil methyl ester.

Preferred further organic solvents for the purposes of the present invention are, in particular, aromatic solvents, such as the Solvesso® series from Exxon and water-miscible ketones, such as acetone.

The customary auxiliaries and additives (4) optionally present in the active ingredient formulations according to the invention are known in principle and are described, for example, in standard works: McCutcheon's “Detergents and Emulsifiers Annual”, MC Publ. Corp., Ridgewood N.J.; Sisley and Wood, “Encyclopedia of Surface active Agents”, Chem. Publ. Co. Inc., N.Y. 1964; Schönfeldt, “Grenzflächenaktive Äthylenoxidaddukte” [Surface-active ethylene oxide adducts], Wiss. Verlagsgesellschaft, Stuttgart 1976; Winnacker-Küchler, “Chemische Technologie”, Volume 7, C.Hauser-Verlag, Munich, 4th edition 1986.

Customary auxiliaries and additives (4) which may also be present in the active ingredient formulations according to the invention are, for example: thickeners and thixotropic agents, wetting agents, anti-drift agents, adhesives, penetration agents, preservatives and frost protection agents, antioxidants, fillers, carriers, dyes, fragrances, antifoams, fertilizers, evaporation inhibitors, and agents which influence the pH and the viscosity.

The active ingredient formulations according to the invention can be prepared by customary processes which are already known, e.g. by mixing the various components with the help of stirrers, shakers, mills or (static) mixers. In this connection, brief heating of the mixtures may in some cases be advantageous in order to achieve complete dissolution of all of the components involved.

The surfactant/solvent mixtures according to the invention permit the preparation of stable formulations with an active ingredient concentration and active ingredient composition which can vary within wide limits. Thus, for example, the active ingredient concentration can vary between 0.1 and 60 percent by weight, preferably between 1 and 45 percent by weight. One, two or more active ingredients may be present.

Using the surfactant/solvent mixtures according to the invention it is possible to prepare active ingredient formulations, preferably liquid active ingredient formulations, in particular of agrochemical, such as herbicidal, insecticidal or fungicidal, active ingredients characterized by a content of
1) 0.1 to 60% by weight, preferably 15 to 35% by weight, of agrochemical active ingredients,
2) 1 to 99.9% by weight, preferably 10 to 70% by weight, of the surfactant/solvent mixture according to the invention, where preferably 0.9-99% by weight, preferably 35-99% by weight, of the solvent of the formula (I) are present,
3) 0 to 80% by weight, preferably 0 to 30% by weight, of further organic solvents,
4) 0 to 20% by weight, preferably 0 to 10% by weight, of customary auxiliaries and additives, such as formulation auxiliaries and
5) 0 to 96% by weight, preferably 0 to 70% by weight, in particular 0 to 10% by weight, of water,
   it being preferred if the solvent of the formula (I) is present in excess relative to the optional organic solvent 3).

Preferred agrochemical active ingredient formulations are:

emulsion concentrates and microemulsion concentrates comprising

1) 0.1 to 60% by weight of agrochemical active ingredients.
2) 10 to 99.9% by weight of the surfactant/solvent mixture according to the invention, where preferably 0.9-99% by weight, preferably 35-99% by weight, of the solvent of the formula (I) are present,
3) 0 to 35% by weight of other organic solvents and
4) 0 to 10% by weight of customary auxiliaries and additives, such as formulation auxiliaries,
   it being preferred if the solvent of the formula (I) is present in excess relative to the optional organic solvent 3).

Emulsions and microemulsions comprising
1) 0.1 to 60% by weight of agrochemical active ingredients,
2) 10 to 60% by weight of the surfactant/solvent mixture according to the invention, where preferably 0.9-59% by weight, preferably 35-59% by weight, of the solvent of the formula (I) are present,
3) 0 to 35% by weight of further organic solvents,
4) 0 to 10% by weight of customary auxiliaries and additives, such as formulation auxiliaries, and
5) 0.001 to 89% by weight of water,
   it being preferred if the solvent of the formula (I) is present in excess relative to the optional organic solvent 3).

Oil suspension concentrates and oil suspensions comprising
1) 0.1 to 60% by weight of agrochemical active ingredients,
2) 10 to 99.9% by weight of the surfactant/solvent mixture according to the invention, where preferably 0.9-99% by weight, preferably 35-99% by weight, of the solvent of the formula (I) are present,
3) 0 to 35% by weight of further organic solvents, and
4) 0 to 10% by weight of customary auxiliaries and additives, such as formulation auxiliaries, in particular 0.001 to 5% by weight of organic and/or inorganic thickeners,
   it being preferred if the solvent of the formula (I) is present in excess relative to the optional organic solvent 3).

Suspoemulsion concentrates and suspoemulsions comprising
1) 10 to 40% by weight of agrochemical active ingredients,
2) 10 to 60% by weight of the surfactant/solvent mixture according to the invention, where preferably 0.9-59% by weight, preferably 35-59% by weight, of the solvent of the formula (I) are present,
3) 0 to 35% by weight of further organic solvents,
4) 0 to 10% by weight of customary auxiliaries and additives, such as formulation auxiliaries, in particular 0.001 to 5% by weight of organic and/or inorganic thickeners, and
5) 0.001 to 80% by weight of water,
   it being preferred if the solvent of the formula (I) is present in excess relative to the optional organic solvent 3).

The abovementioned agrochemical active ingredient formulations can also be additionally diluted with water and form, for example, aqueous spray liquors, which likewise represent active ingredient formulations for the purposes of the present invention.

The surfactant/solvent mixture according to the invention is preferably suitable for the preparation of stable agrochemical active ingredient formulations, in particular liquid agrochemical active ingredient formulations including aqueous spray liquors. The formulations which can be prepared with the surfactant/solvent mixture according to the invention also have biologically advantageous results upon use. Here, an effective amount of the formulation is applied to the pests or the sites at which they appear, e.g. on the plants, parts of plants, plant seeds or the area where plants grow, e.g. the cultivation area. In addition, the biological activity of the agrochemical active ingredients used can be increased through the use of the surfactant/solvent mixture according to the invention, in particular in a synergistic manner.

### EXAMPLES

The formulations given in the table below were prepared as follows:

The solvents a) were initially introduced into a flask. Then, with stirring, the surfactants b) and auxiliaries and additives were added one after the other. The mixtures were then stirred for one hour at 50° C. The resulting formulations were then diluted with water to give a spray liquor and stored for one week in order to analyze the stability. The formulations from Examples 1 and 2 were stable, whereas the formulations from Comparative Examples 1 and 2 were not stable. In the table below, the fractions of the formulation constituents are given (in % by weight).

| Formulation | | | Comparative | Comparative |
|---|---|---|---|---|
| constituents | Example 1 | Example 2 | Example 1 | Example 2 |
| Bromoxynil | 18.22 | 18.22 | 18.22 | 18.22 |
| octanoate | | | | |
| loxynil octanoate | 9.63 | 9.63 | 9.63 | 9.63 |
| Diflufenican | 3.71 | 3.71 | 3.71 | 3.71 |
| AASCA ® 60 | 3.17 | 3.17 | 3.17 | 3.17 |
| Antarox ® 724P | 4.52 | 4.52 | 4.52 | 4.52 |
| N,N-Dimethyl- | | 40.39 | | |
| propionamide | | | | |
| N,N-Dimethyl- | 40.39 | | | |
| isobutyramide | | | | |
| N,N-Dimethyl- | | | | 40.39 |
| formamide | | | | |
| N,N-Dimethyl- | | | 40.39 | |
| acetamide | | | | |
| Solvesso ® 150 | 20.16 | 20.16 | 20.16 | 20.16 |

Explanations:
AASCA ® 60 (Rhodia) = calcium dodecylbenzenesulfonate (60% in isobutanol)
Antarox ® 724P (Rhodia) = ethylene oxide/propylene oxide-(p-nonylphenol) copolymer with 18 EO/PO units
Solvesso ® 150 (Exxon) = aromatic mineral oil

1. A surfactant/solvent mixture comprising
a) one or more solvents of the formula (I):
R—CO—NR¹R² (I)
in which
R=H, methyl, ethyl or propyl, where
α) if R=H or methyl, R¹ and R² are identical or different and are tert-butyl, (C₅-C₁₂)alkyl or (C₁-C₁₂)hydroxyalkyl, and
β) if R=ethyl or propyl, R¹ and R² are identical or different and are (C₁-C₁₂)alkyl or (C₁-C₁₂)hydroxyalkyl, and
b) one or more surfactants.

2. The surfactant/solvent mixture as claimed in claim 1, comprising, as component a), one or more compounds of the formula (I) in which R=ethyl or propyl and R¹ and R² are identical or different and are (C₁-C₆)alkyl.

3. The surfactant/solvent mixture as claimed in claim 1, comprising, as component b), one or more compounds selected from the group consisting of alkoxylated C₁₀-C₂₄-alcohols and anionic derivatives thereof, alkoxylated plant oils, alkoxylated phenols and reaction products thereof with sulfuric acid or phosphoric acid, and alkylbenzenesulfonates.

4. An active ingredient formulation comprising
(1) one or more active ingredients,
(2) the surfactant/solvent mixture as claimed in claims 1,
(3) optionally further organic solvents,
(4) optionally customary auxiliaries and additives, and
(5) optionally water.

5. The active ingredient formulation as claimed in claim 4, comprising one or more agrochemical active ingredients, preferably from the group of herbicides, insecticides or fungicides.

6. The active ingredient formulation as claimed in claim 4, in liquid form.

7. The active ingredient formulation as claimed in claim 4, in the form of an emulsion concentrate, microemulsion concentrate, oil suspension concentrate, suspoemulsion concentrate, emulsion, microemulsion, oil suspension, suspoemulsion, or a spray liquor.

8. A process for the preparation of an active ingredient formulation defined according to claim 4, where the components are mixed together.

9. The use of the surfactant/solvent mixture according to claim 1 for the preparation of active ingredient formulations.

10. The use as claimed in claim 9 for the preparation of emulsion concentrates, microemulsion concentrates, oil suspension concentrates, suspoemulsion concentrates, emulsions, microemulsions, oil suspensions, suspoemulsions or spray liquors.

11. A method of controlling pests, where an effective amount of an agrochemical active ingredient formulation according to claim 4 is applied to the pests or the sites at which they appear.

12. The use of an agrochemical active ingredient formulation as claimed in claim 4, for controlling pests.
